(19) United States
(12) Patent Application Publication
(10) Pub. No.: US 2026/0353180 A1
(43) Pub. Date: Nov. 5, 2026

(54) METHOD, DEVICE, AND COMPUTER PROGRAM FOR REPORTING AN AMOUNT OF PARTICULAR DATA TO BE TRANSMITTED IN A WIRELESS NETWORK

(71) Applicant: CANON KABUSHIKI KAISHA, Tokyo (JP)

(72) Inventors: Stéphane BARON, LE RHEU (FR); Patrice NEZOU, LIFFRE (FR); Julien SEVIN, SAINT AUBIN DU CORMIER (FR)

(21) Appl. No.: 19/124,544

(22) PCT Filed: Oct. 25, 2023
(86) PCT No.: PCT/EP2023/079766

§ 371 Date: Apr. 25, 2025

(30) Foreign Application Priority Data
Oct. 28, 2022 (GB) 2216011.3

(51) Int. Cl. H04W 28/02

(52) U.S. Cl. CPC H04W 28/0278

(57) ABSTRACT

At least one embodiment of a method of communication in a wireless network comprising a plurality of stations, the plurality of stations comprising an emitting station having a plurality of Extended Unique Identifiers, EUIs, simultaneously valid and having at least one buffer to store data to be transmitted to a destination station. The method comprises, at the emitting station, generating a buffer status report, BSR, to be transmitted to the destination station, the BSR indicating an amount of data stored in the at least one buffer of the emitting station, the amount of data being determined as a function of an EUI of the plurality of EUIs, the EUI used for determining the amount of data being used as a source address for transmitting the data.

### FIELD OF THE INVENTION

The present invention relates to wireless communications and to a method, a device, and a computer program for reporting an amount of particular data to be transmitted in a wireless network, that may be used, in particular, to improve user privacy during wireless communications.

### BACKGROUND OF THE INVENTION

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section. Furthermore, all embodiments are not necessarily intended to solve all or even any of the problems brought forward in this section.

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks. The 802.11 family of standards adopted by the Institute of Electrical and Electronics Engineers (IEEE) provides a large number of mechanisms for wireless communications between stations.

Today, the evolution of wireless systems has brought privacy concerns at the forefront, driven by user demand and requirements of the General Data Protection Regulation (GDPR). The global wireless industry is faced with the growing need to protect users' personally identifiable information from increasingly sophisticated user tracking and user profiling activities, while continuing to improve wireless services and the user experience.

In particular, the Media Access Control (MAC) address of a user's device constitutes a piece of data that can be used to track this user. Indeed, the access points (APs) of wireless networks can monitor the locations of mobile devices (tablets, laptops, mobile phones, etc.) of a user without his/her consent, by means of their MAC addresses. This is because mobile phones are configured to discover surrounding access points to wireless networks. As a user moves, his/her mobile phone sends requests to determine if there are any access points nearby, these requests identifying the mobile phone which sends these requests and including in particular the MAC address of the mobile phone. Access points that hear these requests can respond. In the context of Wi-Fi networks as defined by IEEE 802.11 standards (Wi-Fi is a trademark), this procedure is called Probe Request/Response exchange.

So even when a mobile phone is not connected to a Wi-Fi network, surrounding access points may receive its MAC address. It is then possible to track a user by reconstructing his/her trajectory from access points to which his/her mobile phone has sent its MAC address. In addition, if the mobile phone has been associated with one of the access points (i.e. the user has connected to an associated Wi-Fi network through that access point) and the user has provided personal identification information (name, place of residence, etc.) in the past, the access point may have recorded in a database the MAC address of the phone in association with the identification information. Therefore, even if the user is not connected to the Wi-Fi network, this identity information could be recovered by comparing the MAC address contained in a Probe Request to the MAC address used for the past association.

In the context of Wi-Fi networks, a solution has been proposed by the IEEE 802.11 working group to limit the risk of a user being traced, and consists in dynamically modifying the MAC address of the user device. This mechanism is called Randomized and Changing MAC (RCM) procedure. It has been originally introduced as a privacy enhancing feature in the 802.11aq Pre-Association Service Discovery Task Group and finally included in the standard IEEE Std 802.11-2020. It comprises periodical change of the MAC address of a non-AP station (i.e. a station which is not an access point) to a random value, while the non-AP station is not associated with a network (or, equivalently, with an access point). The non-AP station may construct the randomized MAC address from the locally administered address space as defined in IEEE Std 802®-2014 and IEEE Std 802c™-2017.

More specifically, a new Management Information Base (MIB) variable controllable by an external management entity has been specified. This variable is called ‘dot11MACPrivacyActivated’. When dot11MACPrivacyActivated is set to “true”, the non-AP station can apply specific mechanisms for enhancing the privacy at MAC level, including RCM.

The MAC address, or EUI-48 address, of a device is an Extended Unique Identifier (EUI) composed of 48 bits. It can be administered universally or locally. A universally administered address is uniquely assigned to the device by the manufacturer. On the contrary, a locally administered address is assigned to the device by a software or a network administrator, and replaces the physical burned-in address. The second-least-significant bit of the first octet of the MAC address, i.e. the seventh bit of the first octet of the address, also referred to as “U/L bit” (for “Universal/Local bit”), indicates whether it is universally (when set to 0) or locally (when set to 1) administered. The least-significant bit of the first octet of the MAC address, i.e. the eighth bit of the first octet of the address, also referred to as “I/G bit” (for “Individual/Group bit”), indicates whether the frame is sent to only one receiving device (when set to 0, indicating unicast transmission) or to a plurality of devices (when set to 1, indicating multicast transmission). When RCM mechanism is operated in the non-AP station, the MAC address of the non-AP station is randomly changed (for instance periodically). More specifically, the U/L bit is set to 1, the I/G bit is set to 0, and the remaining 46 bits are randomly generated by using a pseudorandom function (PRF). When the RCM is operated, counters in all sequence number spaces used to identify data frames (MAC service data units, MSDUs, packets or Management MAC Protocol Data Units, MMPDUs, frames) have to be reset and the non-AP station also resets seeds used within the PHY DATA scrambler on the next physical layer protocol data unit, PPDU, to be transmitted.

Recent solutions have been proposed to solve the issue, but all suffer from a lack of flexibility regarding the application of a new MAC address. In particular, the change of a MAC address of a non-AP station that is already registered to an AP station needs to terminate ongoing communications prior to the UID change. The same issue occurs when an AP station decides, for instance, to change critical elements of its managed network (like the frequency band). The consequence is that such needs to be carefully anticipated by all the stations in the network by stopping ongoing communication prior to the change.

In such recent mechanisms, in order to allow a seamless change of the MAC address of a non-AP STA while being associated with an AP, both the current and the new MAC addresses need to be valid during the same period of time called the multi MAC address period (or transition period in case of MAC address change). Accordingly, a given station should now support several MAC addresses.

Other arising technologies also require the support of several MAC addresses to increase a station privacy by using a different MAC address per type of communication for instance. This is the case for stations using a MAC address for data transmission and another MAC address for performing positioning determination, or performance feedback.

While these technologies have proven to be effective, there is a constant need for improvement.

### SUMMARY OF THE INVENTION

The present invention has been devised to address one or more of the foregoing concerns.

According to a first aspect of the invention there is provided a method of communication in a wireless network comprising a plurality of stations, the plurality of stations comprising an emitting station having a plurality of Extended Unique Identifiers, EUIs, simultaneously valid and having at least one buffer to store data to be transmitted to a destination station, the method comprising, at the emitting station: generating a buffer status report, BSR, to be transmitted to the destination station, the BSR indicating an amount of data stored in the at least one buffer of the emitting station, the amount of data being determined as a function of an EUI of the plurality of EUIs, the EUI used for determining the amount of data being used as a source address for transmitting the data.

Accordingly, the method of the invention makes it possible for a destination station to have knowledge about the amount of data to be received from an emitting station, that are associated with a given address of the emitting station, which is particularly useful for optimizing the time period needed for changing the address of the emitting station and/or for improving privacy.

In an embodiment, the method further comprises identifying the EUI used for determining the amount of data as a function of a context, which may be explicit or implicit.

In an embodiment, the context is a change of EUI, within the emitting station, from an old EUI to a new EUI, the EUI used for determining the amount of data being the old EUI.

In an embodiment, the method further comprises determining that the at least one buffer of the emitting station does not comprise any data to be transmitted using the old EUI and setting a global queue size field of the BSR to zero.

In an embodiment, the method further comprises preparing a Quality of Service, QoS, NULL frame, the prepared QoS NULL frame comprising the BSR wherein the global queue size field is set to zero, to inform the destination station that no data associated with the old EUI are to be transmitted to the destination station.

In an embodiment, the method further comprises receiving a frame from the destination station, the frame received from the destination station comprising a BSR, wherein the BSR received from the destination station comprises a global queue size field set to zero.

In an embodiment, the method further comprises deactivating the old EUI upon determining that the global queue size field of the BSR received from the destination station is set to zero, meaning that there are no data associated with the old EUI to be transmitted to the destination station or to be received from the destination address.

In an embodiment, the method further comprises activating a timer when a change is to be carried out between the old EUI and the new EUI and comprising deactivating the old EUI when the timer elapses.

In an embodiment, the context is determined as a function of a type of data to be transmitted. The context may be received from the destination station.

According to particular embodiments, the destination station is an access point station, AP, and the emitting station is a non-AP station, STA.

According to a second aspect of the invention there is provided a method of communication in a wireless network comprising a plurality of stations, the plurality of stations comprising an emitting station having at least one buffer to store data to be transmitted to a destination station, the destination station having a plurality of Extended Unique Identifiers, EUIs, simultaneously valid, the method comprising, at the emitting station:
generating a buffer status report, BSR, to be transmitted to the destination station, the BSR indicating an amount of data stored in the at least one buffer of the emitting station, the amount of data being determined as a function of an EUI of the plurality of EUIs, the EUI used for determining the amount of data being used as a destination address for transmitting the data.

Accordingly, the method of the invention makes it possible for a destination station to have knowledge about the amount of data to be received from an emitting station, using one of several destination addresses of the destination station, which is particularly useful for optimizing the time period needed for changing the address of the destination station and/or for improving privacy. This is particularly useful when the at least one buffer of the emitting station comprises data to be transmitted to the same destination station using different destination addresses of the destination station.

In an embodiment, the method further comprises identifying the EUI used for determining the amount of data as a function of a context, which may be explicit or implicit.

In an embodiment, the context is a change of EUI, within the destination station, from an old EUI to a new EUI, the EUI used for determining the amount of data being the old EUI.

In an embodiment, the method further comprises receiving a frame from the destination station, the frame received from the destination station comprising a BSR, wherein the BSR received from the destination station comprises a global queue size field set to zero.

In an embodiment, the method further comprises determining that the at least one buffer of the emitting station does not comprise any data to be transmitted to the destination station using the old EUI as a destination address and setting a global queue size field of the BSR to zero.

In an embodiment, the method further comprises deactivating the old EUI.

In an embodiment, the method further comprises activating a timer when a change is to be carried out between the old EUI and the new EUI and comprising deactivating the old EUI when the timer elapses.

In an embodiment, the context is determined as a function of a type of data to be transmitted. The context may be transmitted to the destination station.

According to particular embodiments, the emitting station is an access point station, AP, and the destination station is a non-AP station, STA.

In an embodiment, the method further comprises transmitting the generated BSR to the destination station.

In an embodiment, the EUI used for determining the amount of data is a MAC address.

In an embodiment, the at least one buffer comprises a plurality of queues, each queue of the plurality of queues corresponding to an Access Category, AC.

According to another aspect of the invention there is provided a computer program product for a programmable apparatus, the computer program product comprising a sequence of instructions for implementing a method according to the invention, when loaded into and executed by the programmable apparatus.

According to another aspect of the invention there is provided a device comprising a processing unit configured to carry out each step of the method described above.

Still according to another aspect of the invention there is provided a computer-readable storage medium storing instructions of a computer program for implementing the method described above.

The advantages of such a device and such a computer-program are similar to those of the method described above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Some embodiments of the present invention are illustrated by way of example, and not by way of limitation, in the figures of the accompanying drawings, in which like reference numerals refer to similar elements and in which:

FIG. 1 illustrates an example of a network system in which some embodiments of the invention may be implemented;

FIG. 2 illustrates the frame format of a MAC data frame containing a BSR;

FIG. 3a illustrates an example of steps performed at a non-AP station for changing its MAC address, according to some embodiments of the invention;

FIG. 3b illustrates an example of steps carried out by an AP station for changing the MAC address of one of its associated non-AP stations, according to some embodiments of the invention;

FIG. 4 illustrates an example of steps performed at a non-AP station or at an AP station upon reception of a frame or when a frame is ready for transmission, according to some embodiments of the invention;

FIG. 5 illustrates an example of sub-steps of a step of creating a new BSR, for example as described in reference to FIG. 4;

FIG. 6 illustrates a first example of a sequence of steps for operating a procedure for changing the MAC address of a non-AP station associated with an AP station, according to some embodiments of the invention;

FIG. 7 illustrates a second example of a sequence of steps for operating a procedure for changing the MAC address of a non-AP station associated with an AP station, according to some embodiments of the invention;

FIG. 8 illustrates a first example of steps performed by a non-AP station and its associated AP station during a multi MAC address period 800, corresponding to a MAC address transition period of a station, according to some embodiments of the invention;

FIG. 9 illustrates a second example of steps performed by a non-AP station and its associated AP station during a multi MAC address period 800, corresponding to a MAC address transition period of a station, according to some embodiments of the invention; and

FIG. 10 illustrates an example of a communication device of a wireless network, configured to implement at least one embodiment of the present invention.

### DESCRIPTION OF SOME EMBODIMENTS

The inventors have observed that information about the content of buffers of a station, in relation to one or several of its addresses (e.g. MAC addresses), when several addresses may be used in the same period of time, may be needed by an access point (AP) station to manage efficiently its BSS.

This is especially true for a station applying a seamless change of its MAC address, from a current MAC address to a new MAC address, during a transition period (i.e. a multi MAC address period). In such a case, one of the main issues is to determine the effective ending time of the transition period. The transition period ending time being determined by the end of usage of the current MAC address on both side (non-AP station and AP sides), there is a need for a station to determine the amount of data (or the number of packets) associated with the current MAC address (or more generally with a given MAC address), that are to be transmitted by the remote station.

According to some embodiments, a buffer status report (BSR) is used to provide information on data in buffers of an emitting station, to a receiving station, these data being associated with a particular MAC address of the emitting station. This particular MAC address may be identified as a function of a context (e.g. a transition period between two MAC addresses) or may be explicitly indicated by the receiving station.

In the following, the procedure for changing a privacy parameter, e.g. the MAC address of a non-AP station already associated with an AP station, is referred to as “Enhanced RCM procedure”, ERCM procedure, or “Seamless Enhanced RCM procedure”, SERCM procedure. Therefore, all the acronyms “ERCM” used in the description may be replaced by “SERCM”. ERCM or SERCM may be implemented on non-AP station's initiative to change one of its own privacy parameters or on AP station's initiative to change one of AP's own privacy parameters.

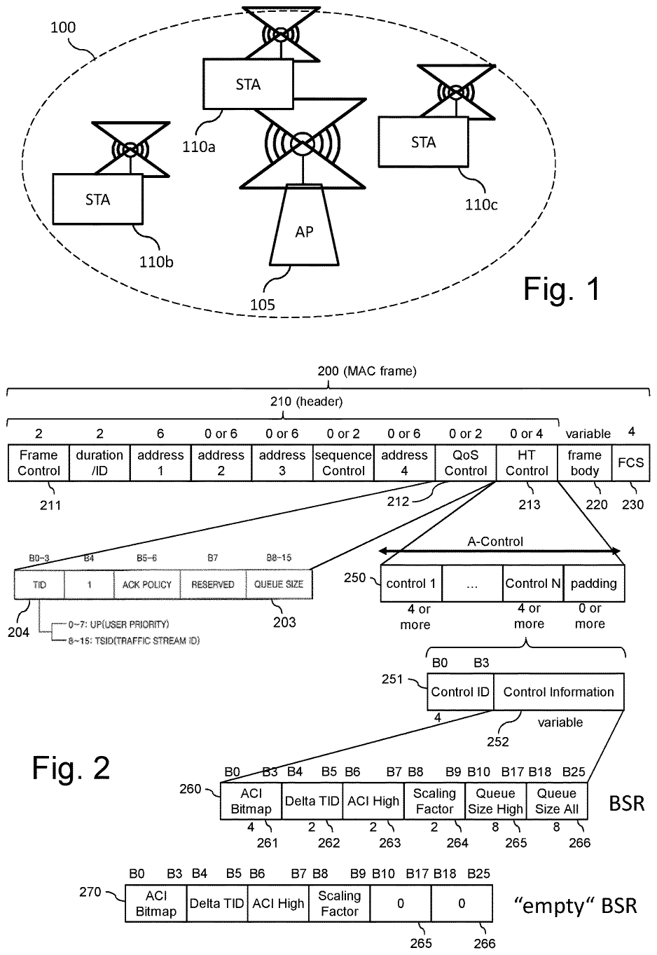

FIG. 1 illustrates an example of a network system in which some embodiments of the invention may be implemented.

For the sake of illustration, FIG. 1 represents an 802.11 network (i.e. a Wi-Fi network) system 100 comprising four wireless devices: an access point station (AP) 105 and three non-AP stations (non-AP STAs) 110a, 110b, and 110c. Of course, the number of non-AP stations 110a, 110b, and 110c may be different from three. AP station 105 provides wireless connections between non-AP stations 110a, 110b, 110c and a wider network, such as the Internet (not represented). The connection of one of non-AP station 110a, 110b, and 110c to AP 105 may be performed by a standardized process called association. Once a non-AP station is associated with the AP station, the non-AP station can send data to the network and receive data from the network through the AP station.

AP station 105 may comprise, be implemented as, or known as a Node B, Radio Network Controller (RNC), evolved Node B (eNB), 5G Next generation base station (gNB), Base Station Controller (BSC), Base Transceiver Station (BTS), Base Station (BS), Transceiver Function (TF), Radio Router, Radio Transceiver, Basic Service Set (BSS), Extended Service Set (ESS), Radio Base Station (RBS), or some other terminology. It can be a standalone product or it may be integrated in a device, for instance in a broadband remote access server (BRAS).

Non-AP stations 110a, 110b, and/or 110c may comprise, be implemented as, or known as a subscriber's station, a subscriber unit, a mobile station (MS), a remote station, a remote terminal, a user terminal (UT), a user agent, a user device, a user equipment (UE), a user station (STA), or some other terminology. In some implementations, a non-AP station may be or may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or a smartphone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, some of non-AP stations 110a, 110b, and 110c may be wireless nodes. Such a wireless node may provide, for example, connectivity for or to a network (e.g., a wide area network such as the Internet or a cellular network) via a wired or wireless communication link.

AP station 105 manages a set of stations that together organize their accesses to the wireless medium for communication purposes. All the stations (AP station 105 and non-AP stations 110a, 110b, and 110c) form a service set, which may be referred to as basic service set, BSS (although other terminology can be used). It is noted that AP station 105 may manage more than one BSS: each BSS is thus uniquely identified by a specific basic service set identifier (BSSID) and managed by a separate virtual AP station implemented in physical AP station 105.

It is to be recalled that the management of the quality of service (QoS) is handled at the station level in the wireless networks, through the EDCA mechanism defined in the IEEE 802.11e standard. EDCA (Enhanced Distributed Channel Access) mechanism defines four traffic access categories (ACs) or “priorities” to manage access to the medium: a voice access category (AC_VO) and a video access category (AC_VI) both reserved for real-time applications (e.g. voice or video transmission), a best effort access category (AC_BE) for standard applications, and a background access category (AC_BK) when traffic is low.

Four corresponding emission buffers (or transmission/traffic queues or buffers) are generally provided: each AC has its own traffic queue/buffer to store corresponding traffic as data frames such as MSDUs or A-MSDUs to be transmitted over the network. The data frames, namely the MSDUs, incoming from an upper layer of the protocol stack are each provided with an 802.1D priority or User priority (UP) or traffic type (TID—standing for Traffic Identifier) taking values in the range 0-7. Based on their TID, the MSDUs are mapped, using mapping rules, onto one of the four AC queues/buffers to be stored in the mapped AC buffer. Of course, another number of traffic queues may be contemplated.

Since the AP performs contention on behalf of the non-AP stations in the Uplink OFDMA, it should be aware of both the non-AP stations having (in their buffers) uplink traffic (MSDUs) to transmit and the amount of buffered uplink traffic (UL) traffic.

The 802.11 standard proposes that the 802.11ax non-AP stations send a buffer status report (BSR) to the AP to report the buffered traffic. The BSR may be included in a BSR control field provided in MAC data frames.

FIG. 2 illustrates a MAC data frame 200 comprising a MAC header 210, a frame body 220, and a FCS field 230. As illustrated, the MAC header 210 includes, amongst other fields, a Frame Control header 211, a QoS control field 212 and a HT control field 213. The QoS control field 212 is the original 802.11e format that may be used by a non-AP station of any 802.11 technology to report a buffer status. The size of each field (in bytes) is indicated just above the corresponding box.

Alternatively, or possibly additionally, a non-AP station starting from 802.11ax version (including further releases such as 802.11be/EHT) may use the HT control field 213 to do so.

As described above, an 802.11 station (AP or non-AP station) maintains four Access Categories (ACs), and thereby uses four corresponding emission buffers (or transmission/traffic queues or buffers). Each AC has its own traffic queue/buffer to store corresponding data frames to be transmitted over the network. The data frames, namely the MSDUs (MAC service data units), incoming from an upper layer of the protocol stack are mapped onto one of the four AC queues/buffers and thus input in the mapped AC buffer. Therefore, an 802.11 station supports a traffic prioritization similar to DiffServ (Differentiated Services), and the mapping is performed between one of the eight priorities of traffic class of the incoming MSDU (TID values between 0-7 are considered User Priorities and these are identical to the IEEE 802.1D priority tags) onto a corresponding one of the four ACs.

### 802.11 Legacy BSR Format

As represented in FIG. 2, the QoS control field 212 is made of two bytes, including the following information items:
bits B0 to B3 are used to store a traffic identifier (TID) 204 which identifies a traffic stream. The traffic identifier takes the value of the transmission priority value (User Priority (UP) that value is between 0 and 7) corresponding to the data conveyed by the data frame or takes the value of a traffic stream identifier, TSID, having a value between 8 and 15, for other data streams;
bit B4 is used by a non-AP station to differentiate the meaning of bits B8-B15 as follows:
   if bit B4 is set to 1, bits B8-B15 represent the “queue size” subfield 203, to indicate the amount of buffered traffic data for a given TID at the non-AP station sending this frame. The queue size value is the total size, rounded up to the nearest multiple of 256 octets and expressed in units of 256 octets, of all packets buffered for the specified TID. The access point station may use this information to determine the next TXOP duration it will grant to the non-AP station. A queue size of 0 indicates the absence of any buffered traffic data for that TID. A queue size of 255 indicates an unspecified or unknown size for that TID 204,
   alternatively to the “queue size” use, if bit B4 is set to 0, bits B8-B15 represent the “TXOP Duration Requested” subfield. It indicates the duration, in units of 32 microseconds, that is determined by the sending station to handle its next TXOP for the specified TID. Of course, the “TXOP Duration Requested” provides an equivalent request as the “queue size”, as they both consider all packets buffered for the specified TID;
bits B5 and B6 define the ACK policy subfield which specifies the acknowledgment policy associated with the data frame. This subfield is used to determine how the data frame has to be acknowledged by the receiving station: normal ACK, no ACK, or Block ACK; and
bit B7 is reserved, meaning not used by the current 802.11 standards.

The following description is based on the “queue size” format for the buffer status reports, as it is the largest use (the “TXOP Duration Requested” format is deprecated for MU usage). The 802.11e MAC frame format, and more particularly the QoS Control field 200, have been kept for the up and corner standard versions as now described.

The legacy BSR according to 802.11e can handle one TID report per MSDU frame, this is one reason why enhancements were later provided by 802.11ax version.

### 802.11ax BSR Format

As illustrated in FIG. 2, the HT-Control field 213 may aggregate multiple control fields, resulting in a sequence of one or more Control subfields 250 that size (in bits) is indicated just below the corresponding box. The length of the aggregated control field (A-Control field) 213 is equal to 30 bits. As also illustrated, each Control subfield 250 includes a Control ID 251 subfield indicating the type of information carried in the Control Information subfield 252 that follows. Padding bits are added if necessary to reach the 30 bits of the A-Control field.

Various types of information may thus be provided through the A-Control field 213 depending on the Control ID 251. For instance, operating mode may be indicated in Control Information subfield 252 when Control ID 251 is 1. Also, power data may be indicated in Control Information subfield 252 when Control ID 251 is 4.

If Control ID subfield 251 is 3, Control Information subfield 252 of the Control subfield 250 contains buffer status information in the format of a BSR control field shown in FIG. 2 under reference 260. A non-AP station may report the buffer status for a preferred AC or for all AC queues. As illustrated in FIG. 2, the Buffer Status Information 260 is made up of six subfields: ACI Bitmap 261, Delta TID 262, ACI High 263, Scaling Factor 264, Queue Size High 265, and Queue Size All 266, that size (in bits) is indicated just below the corresponding box.

A number N_{TID} of traffic identifiers for which there are buffered uplink, UL, traffic data, is signaled using the first two subfields in the BSR control field 260, namely ACI Bitmap 261 and Delta TID 262.

ACI Bitmap subfield 261 has four bits and indicates the access categories for which the buffer status is reported. Each bit of the ACI Bitmap subfield 261 is associated with one of the four ACs and is set to 1 to indicate that the buffer status of the corresponding AC is included in the Queue Size All subfield 266, otherwise it is set to 0.

Exception is made for the particular case where the buffer statuses for all eight TIDs are included in the Queue Size All subfield 266. In that case, ACI Bitmap subfield=0 is combined with Delta TID subfield 262 set to 3.

Delta TID subfield 262 together with the values of the ACI Bitmap subfield indicate the number of TIDs for which the non-AP station is reporting the buffer status. The table below gives the relationships between these two subfields and the number of TIDs. The table comes from table 9-24d of document 802.11 ax, version 6.0.

| Number N_{bit} of | |
|---|---|
| bits in ACI | |
| Bitmap subfield | |
| 261 that are | Mapping of Delta TID subfield value and number |
| set to 1 | of TIDS, N_{TID} |
| 0 | Values 0 to 2 are not applicable; |
| | Value 3 indicates 8 TIDs (i.e., all ACs have traffic) |
| 1 | Value 0 indicates 1 TID; Value 1 indicates 2 TIDs; |
| | Values 2 to 3 are not applicable; |
| 2 | Value 0 indicates 2 TIDs; Value 1 indicates 3 TIDs; |
| | Value 2 indicates 4 TIDs; Value 3 is not applicable; |
| 3 | Value 0 indicates 3 TIDs; Value 1 indicates 4 TIDs; |
| | Value 2 indicates 5 TIDs; Value 3 indicates 6 TIDs; |
| 4 | Value 0 indicates 4 TIDs; Value 1 indicates 5 TIDs; |
| | Value 2 indicates 6 TIDs; Value 3 indicates 7 TIDs; |

ACI High subfield 263 is used to indicate the ACI (Access Control Identifier) of a preferred AC for which the amount of buffered traffic is specified in Queue Size High subfield 265.

Scaling Factor (SF) subfield 264 indicates the unit SF, in octets, of Queue Size High and Queue Size All subfields 265 and 266.

Queue Size High subfield 265 indicates the amount of buffered traffic data, in units of SF octets, for the AC identified by ACI High subfield 263 that is intended for the station (usually the AP station) identified by the receiver address of the MAC frame 200.

Queue Size All subfield 266 indicates the amount of buffered traffic data, in units of SF octets, for all the ACs identified by ACI Bitmap subfield 261 that is intended for the station (usually the AP station) identified by the receiver address of the MAC frame 200.

The queue size values set in Queue Size High and Queue Size All subfields 265, 266 are the total sizes, rounded up to the nearest multiple of SF octets, of all MSDUs and A-MSDUs buffered at the non-AP station reporting its buffer statuses.

FIG. 2 also contains an example of encoding of a BSR referenced 270 to indicate that there is no more data to be transmitted in the buffer. In this special encoding, the station may indicate any valid encoding for the first 10 bits, but needs to set all remaining bits to 0 (B10 to B25) to indicate that its buffer is empty.

As described above, recent IEEE 802.11amendments like IEEE802.11aq or more recently 802.11bi, that are dedicated to the protection of the user privacy, proposed some mechanisms to avoid the tracking of a device. Those mechanisms mainly rely on an obfuscation of any Unique Identifier, and especially the MAC address that is sent in clear in each and every frame exchanged by a given station. Such new technologies then propose to change the MAC address even while being associated with a BSS. To avoid the break of the ongoing transmission, the support of several MAC addresses for a single STA has been introduced. Currently, the BSR send by these new generations of stations cannot take into account the different MAC addresses handled by the station, and a station sending a BSR to an AP station for instance indicates the amount of the total content of the buffered traffic data for each Access Category regardless of the source MAC address used in the buffered frames.

### Change of MAC Addresses

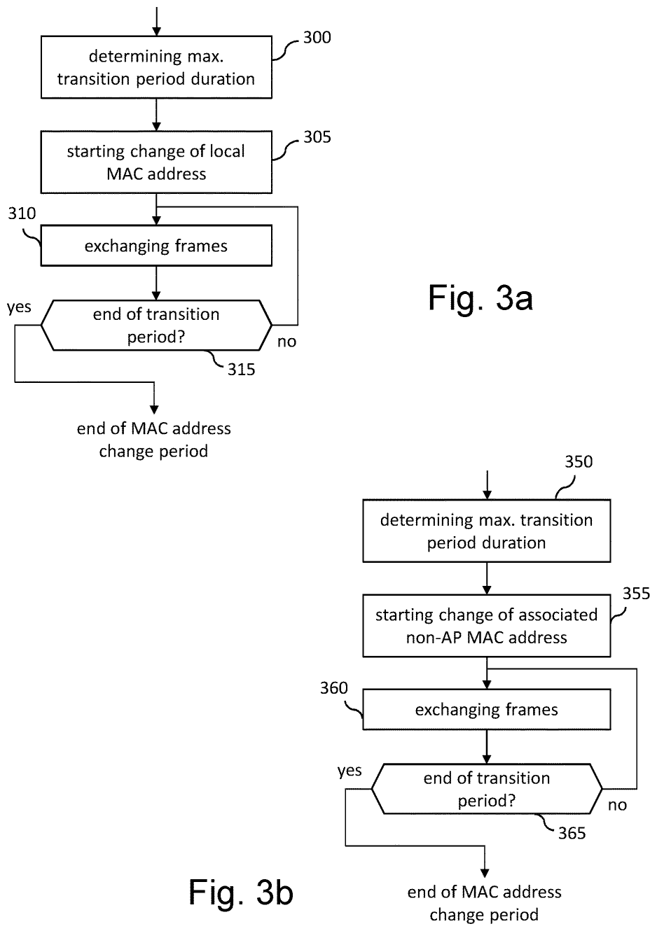

FIG. 3a illustrates an example of steps performed at a non-AP station to change its MAC address, according to some embodiments of the invention.

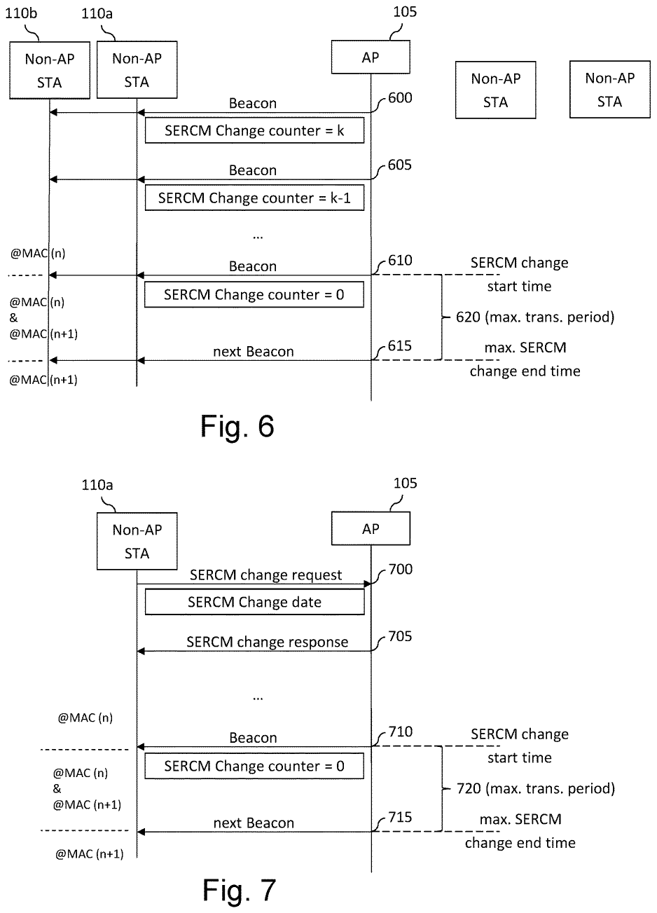

The algorithm illustrated in FIG. 3a is carried out by a non-AP station at a SERCM change start time, for example the start time referenced 610 in FIG. 6 or 710 in FIG. 7.

As illustrated, a first step is directed to determining a maximum SERCM transition period duration (step 300), referred to as the SERCM transition period duration, transition period duration, or transition duration hereafter. This duration can be defined as a time value expressed in milliseconds, TU (Time Unit), as a number of TBTTs (Target Beacon Transmission Times), or by any other indication representative of a duration. According to some embodiments, determining the SERCM transition period duration is based on a level of use of a transmission buffer and/or by retrieving a value stored upon reception of an information element. According to other embodiments, the transition duration is a predefined value, for example a value defined by the 802.11 standard. Still according to other embodiments, the transition duration is a combination of a received value and a value set by an administrator, for example the maximum of a received value and a value set by an administrator.

Next, the change of the local MAC address, from the current MAC address (also referred to as the old MAC address), denoted @MAC(n), to a new MAC address, denoted @MAC(n+1), begins by initiating the transition period (step 305). Initiating the transition period may comprise indicating to the physical (PHY) layer that new MAC address @MAC(n+1) should be added to the list of MAC addresses that the AP station handles, as a transient MAC address. From the PHY layer point of view, all the packets addressed with one of the MAC addresses included in this list should be decoded and forwarded to the MAC layer for further actions. Currently, the MAC layer already handled different MAC addresses (typically, the PHY handle a single unicast MAC address of the station, and potentially group addresses of groups to which belongs the station).

In some embodiments of the invention, the PHY layer of the considered non-AP station handles two unicast MAC addresses: the first one is the classical unicast MAC address of the station seen as a unique identifier of the station and the second one is a transient unicast MAC address. The presence of two unicast MAC addresses is only valid during the transition period. The setting of the unicast MAC addresses by the MAC layer can for instance be performed thanks to a request known as the PHY-CONFIG request that is part of the PHY SAP (Service Access Point) interface as defined in the 802.11 standard. In some embodiments of the invention, a function is added to the PHY SAP to define the transient MAC address. In other embodiments, the transient MAC address is added as a new parameter to the PHY CONFIG function that is used to configure the different parameters of the PHY layer.

After setting the transient MAC address with the new MAC address, the PHY layer is able to decode the frames address to the non-AP station (value of the RA field) either by its unique MAC address or its transient MAC address.

In addition, during the step of initiating the transition period (step 305), the non-AP station set the value of two bits that may be used to determine the status of its local transmission buffer, denoted Local transmission Buffer Status (or LocalBS) in the following, and of the transmission buffer of the AP station with which the non-AP station is associated, denoted RemoteBS in the following. These two bits respectively indicate whether the local transmission buffer and the AP station's transmission buffer contain some packets that are ready for transmission and that are to be addressed according to the old MAC address (i.e. @MAC(n)), or contain some frames ready for transmission or retransmission and that are addressed with the old MAC address. According to some embodiments, the RemoteBS bit is set to false to indicate that the non-AP station considers that the transmission buffer of the AP station contains data to be transmitted with the old MAC address, during the step of initiating the transition period. During the transition period, the RemoteBS bit is set to true to indicate that the non-AP station considers that the transmission buffer of the AP station does not contain data to be transmitted with the old MAC address. Still during the step of initiating the transition period, the LocalBS is set to false if the local transmission buffer is not empty (meaning that the local buffer contains data to be transmitted with the old MAC address) and to true otherwise.

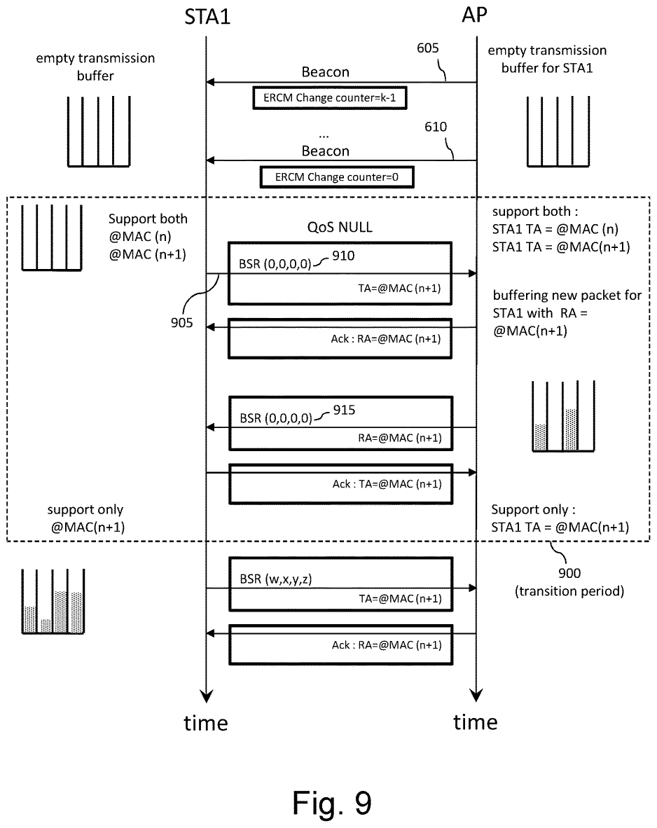

In some embodiments, if the station determines that there is no data currently stored in its buffer, the station set its LocalBS bit to true and prepares a QoS NULL frame (e.g. QoS NULL frame 905 in FIG. 9, corresponding to data frame 200 with an empty Frame Body 220 in FIG. 2), including an empty BSR (e.g. empty BSR 270 in FIG. 2) for transmission to the remote station. In this embodiment, the transmission of a QoS NULL frame speeds up the process of transition of the MAC address of the station by immediately indicating to the remote station that the current station has no old data buffered (i.e. frames buffered with the old MAC address). Without this emission of an empty BSR, the station should wait for new data to transmit or wait for the expiration of the transition buffer.

An example of this embodiment is described in reference to FIG. 9.

As mentioned above, the transition period ends after a transition period duration or earlier depending on the state of the local buffer and of the transmission buffer of the AP station. Accordingly, in some embodiments, the non-AP station initiates a timer with the duration value determined at step 300. When this timer expires, the transition period ends. In such a case, both LocalBS and RemoteBS bits are forced to true, and the MAC address change period ends.

The use of a timer to limit the maximum duration of the transition period may be relevant in particular conditions, for example when a station cannot completely transmit all frames buffered with the old MAC address. In such a case, at the timer expiration, the station discards the remaining buffered packets addressed with the old MAC address and the MAC address change can be effective.

According to some embodiments, all the new packets prepared for transmission and stored in the local transmission buffer are addressed, during the transition period, using the value of the transient MAC address (new Mac address @MAC(n+1)). This ensures that no new packet addressed with the old MAC address (@MAC(n)) are added to the local transmission buffer.

As illustrated in FIG. 3a, the non-AP station sends and receives packets, during step 310, to purge the content of its transmission buffer that may contain some packets prepared in advance and that contain the old MAC address (@MAC(n)). The transmission of these packets follows the usual medium access rules as defined by the standard.

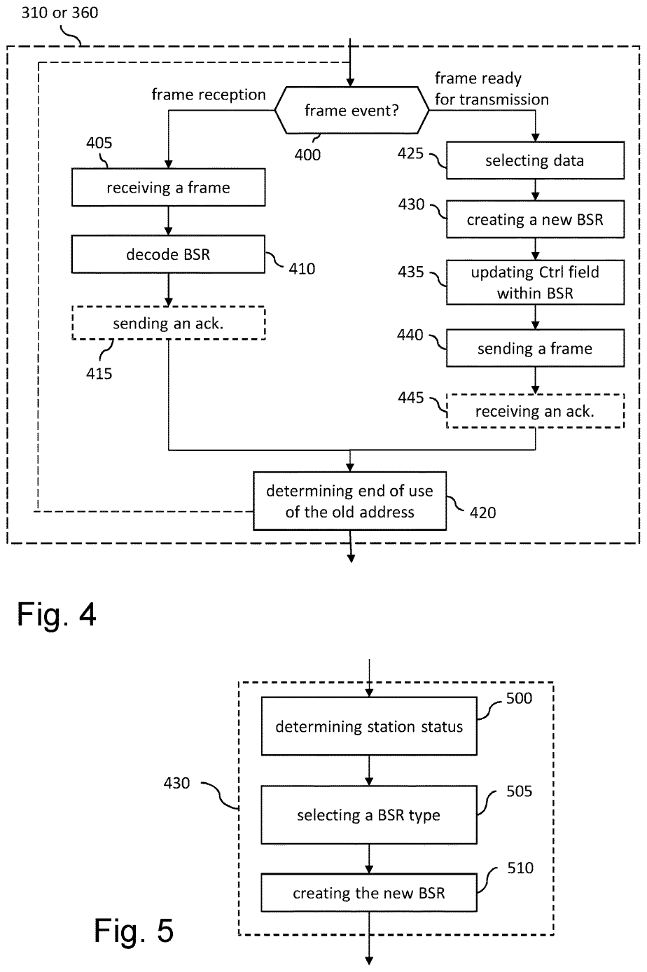

An example of a mechanism for sending and receiving packets (step 310) is described in more details with reference to FIG. 4.

After receiving or transmitting packets (or in parallel), the non-AP station determines whether the transition period should be stopped (step 315). The transition period should be stopped either because it is determined that the old MAC address is not needed any more or because the maximum transition period duration elapsed.

According to some embodiments, if both LocalBF and the RemoteBF bits are set to true, the non-AP station determines that the old MAC address is not needed any more and the transition period ends. Otherwise, the algorithm loops on step 310 as illustrated.

When both LocalBF and the RemoteBF bits are set to true, the non-AP station set the “standard” unique MAC identifier with the value of the transient MAC address. In this case, the two MAC addresses (i.e. the MAC address and the transient MAC address) have the same value, and the transition period is considered as over. In some embodiments, if a timer has been set during the MAC address initiation process (step 305), the timer is deactivated.

If the maximum transition period duration elapses while the old MAC address is still used, the packets or the frames stored in the non-AP station's transmission buffer, that should use the old MAC address to be transmitted, may be discarded. In some embodiments, these packets may be modified so as to be transmitted with the new MAC address.

FIG. 3b illustrates an example of steps carried out by an AP station for changing the MAC address of one of its associated non-AP station, according to some embodiments of the invention.

Similarly to the algorithm described by reference to FIG. 3a, the algorithm illustrated in FIG. 3b is carried out by an AP station at a SERCM change start time, for example the start time referenced 610 in FIG. 6 or 710 in FIG. 7.

Likewise, a first step is directed to determining a maximum SERCM transition period duration (step 350), also referred to as the SERCM transition period duration, transition period duration, or transition duration. Step 350 is similar to step 300 in FIG. 3a. The SERCM transition period duration may be based on a level of use of a transmission buffer and/or retrieved from a value stored upon reception of an information element. According to other embodiments, the transition duration may be a predefined value, for example a value defined by the 802.11 standard, or may correspond to a combination of a received value and a value set by an administrator, for example the maximum of a received value and a value set by an administrator.

Next, the change of the MAC address of the considered non-AP station, from the current MAC address (also referred to as the old MAC address) @MAC(n) to the new MAC address @MAC(n+1), begins (step 355) by indicating, in association with the non-AP station, a transient MAC address (@MAC(n+1)) in addition to its unique MAC address (@MAC(n)). It is recalled here that AP stations maintain some internal table to store a set of parameters for each station associated with it. In some embodiments, the transient MAC address is a new entry of this table and is set with the value of the new MAC address for the considered non-AP station.

In addition, during the step of initiating the transition period (step 355), the AP station set the value of two bits, associated with the considered non-AP station (i.e. the non-AP station that MAC address is being changed), which may be used to determine the status of its local transmission buffer, denoted Local transmission Buffer Status (or LocalBS) in the following, and of the transmission buffer of the considered non-AP station, denoted RemoteBS in the following. These two bits respectively indicate whether the AP station's transmission buffer and the considered non-AP station's transmission buffer contain some frames that are ready for transmission and that are to be addressed according to the old MAC address (i.e. @MAC(n)). According to some embodiments, the RemoteBS bit is set to false to indicate that the AP station considers that the transmission buffer of the considered non-AP station contains data to be transmitted with the old MAC address, during the step of initiating the transition period. During the transition period, the RemoteBS bit is set to true to indicate that the AP station considers that the transmission buffer of the non-AP station does not contain data to be transmitted with the old MAC address. Still during the step of initiating the transition period, the LocalBS is set to false if the AP station's transmission buffer contains data to be transmitted to the considered non-AP station (with the old MAC address) and to true otherwise.

As mentioned above, the transition period ends after a transition period duration or earlier depending on the state of the local buffer and of the transmission buffer of the considered non-AP station. Accordingly, in some embodiments, the AP station initiates a timer with the duration value determined at step 350. When this timer elapses, the transition period ends. In such a case, both LocalBS and RemoteBS bits are forced to true, and the MAC address change period ends.

According to some embodiments, all the new packets prepared for transmission to the considered non-AP station and stored in the local transmission buffer are addressed, during the transition period, using the value of the transient MAC address of the considered non-AP station (new Mac address @MAC(n+1)). This ensures that no new packet addressed with the old MAC address (@MAC(n)) is added to the transmission buffer.

Steps 360 and 365 in FIG. 3b are similar to steps 310 and 315 described by reference to FIG. 3a.

If the maximum transition period duration elapses while the old MAC address is still used, the packets or the frames stored in the AP station's transmission buffer, that should use the old MAC address to be transmitted, may be discarded. In some embodiments, these packets may be modified so as to be transmitted with the new MAC address.

An example of a mechanism for sending and receiving packets (step 360) is described in more details with reference to FIG. 4.

FIG. 4 illustrates an example of steps performed at a non-AP station or at an AP station upon reception of a frame or when a frame is ready for transmission (e.g., step 310 or 360 in FIG. 3a or 3b, respectively), according to some embodiments of the invention.

As illustrated, upon detecting a frame event (step 400) and if the frame event is directed to reception of a frame, the frame is received (step 405) by the station to which it is addressed (the considered non-AP station or the AP station with which the considered non-AP station is associated). A test is carried out to determine whether the received frame contains a BSR.
If the received frame contains a BSR, the BSR is decoded (step 410) and it is determined from the decoded BSR whether the remote station declared that all its buffers do not contain any packet addressed with the old MAC address. This may be done by determining that the received BSR is an empty BSR (indicating that there are no remaining buffered data that should be addressed with the old MAC address), for instance if the received BSR corresponds to BSR 270 in FIG. 2, and by identifying a particular context corresponding to a multi MAC address period, for example by determining that the station is currently in a transition period. If the received BSR is an empty BSR (e.g. BSR 270 in FIG. 2) and the station is in a transition period, the RemoteBS bit is set to true. The determination that the station is in a transition period may be done by checking the value of the RemoteBS and LocalBS bits, or by checking whether the transition timer is active. In other words, if a station receives an empty BSR (a BSR indicating no remaining buffered data) and the station is in a transition period, the station considers that the remote station is ready to finish the transition period.

In addition, if the received frame requires an acknowledgment, an acknowledgment is sent to the station having transmitted the frame (step 415), otherwise step 420 is directly carried out (as suggested with the dotted line, step 415 is optional).
Next, after having sent an acknowledgment or if no acknowledgment is to be sent, the station having received the frame determines whether the old MAC address of the considered non-AP station is still used and thus, whether the change of MAC address is done. If both the LocalBF and the RemoteBF bits are set to true, the station determines that the old MAC address does not need to be maintained anymore and thus, that the transition period may be terminated (as described by reference to steps 315 and 365 in FIGS. 3a and 3b, respectively). In other words, when both non-AP STA and AP are ready to finish the transition period, then the transition period ends and both non-AP station and AP release the old MAC address.

As illustrated, upon detecting a frame event directed to transmission of a frame (step 400), e.g., by determining that the local transmission buffer of the station carrying the steps illustrated in FIG. 4 is not empty, the station tries to access the medium for data transmission, and transmits at least a part of the buffered data (step 440). The data are sent to the considered non-AP station or to the AP station with which the considered non-AP station is associated (depending on whether the steps illustrated in FIG. 4 are carried out in the considered non-AP station or in the AP station with which the considered non-AP station is associated).

According to some embodiments, the station selects the data to be transmitted (step 425), prior to transmitting the frame (step 440). In this selection step, classical EDCA rules may apply to determine the type of data that is to be transmitted. In these embodiments, when a backoff counter corresponding to an Access category queue reaches zero, the station selects data from the corresponding queue. However, if the station is in a transition period, the station should not transmit data with different source addresses in the same transmission opportunity (TXOP). So, if the selected AC contains data addressed with the old and the new MAC address, the station should refrain from transmitting a frame with a different source address than the one of the first packet it transmits during the TXOP and may finish its transmission opportunity earlier (it may for instance transmit a CFEND control frame to indicate an early termination of the TXOP).
Next, after selecting the data to be transmitted, the station creates a new BSR (step 430), for example BSR 260 in FIG. 2. In this embodiment, the content of the BSR is used to indicate the amount of data that remain in the buffer, after transmitting the frame at step 440, that are addressed with the old MAC address. This BSR, once received by the destination station (or the AP station), clearly indicates whether or not the station has finished transmitting frames addressed with its old MAC address and, if not, the remaining amount of data buffered with the old MAC address. An important advantage of this embodiment is that it makes it possible for a station to determine the status of a remote buffer related to the old MAC address using an existing, not dedicated, message. Indeed, BSRs are typically used for reporting a buffer status, not for signaling an address change. Hence, by using BSRs for signaling an address change according to an embodiment of the invention, tracking of an address change by another device is prevented or not eased. In other words, the change of a MAC address is not easily detectable since additional mechanism described here are based on existing signaling (BSR). However, the stations that are aware that a station is changing its MAC address (typically a non-AP station changing its MAC address and its associated AP) may interpret this BSR as a BSR dedicated to the status of the buffer related to the old MAC address. In this embodiment, a station that is in a transition period, computes BSR based on the quantity of data buffered that are addressed only with the old MAC address.

FIG. 5 illustrates an example of sub-steps of a step of creating a new BSR, for example as described in reference to FIG. 4 (step 430).

As illustrated, a first step is directed to the determination of the status of the station (step 500), for instance with regard to a context or the change of the MAC address. This can be done by checking the value of the LocalBF bit or by checking whether the transition timer is active. Next, the station selects a type of BSR as a function of the status of the station (step 505). In some embodiments, if the station is in a transition period, the BSR is computed based on the old MAC address (or old source MAC address) and if the station is not in a transition period, the BSR is computed based on the total amount of data per AC, without considering the source address of the buffered frames.

Next, the station creates a BSR (step 510), for example BSR 260 in FIG. 2, according to the method of BSR computation determined at step 505. If the station determines during this computation that there is no more data buffered in any queue that are addressed with the old MAC address, the station creates an “empty” BSR, for example “empty” BSR 270 in FIG. 2, which indicates that no remaining data are buffered, and set its internal LocalBF bit to true. The emission of an “empty” BSR indicates to a remote station that the station will not use the old MAC address any more.

Back to FIG. 4, if the frame transmitted at step 440 requires an acknowledgment, the station waits for an acknowledgment (step 445), otherwise step 420 is directly carried out (as suggested with the dotted line, step 445 is optional).

Upon receiving an acknowledgement corresponding to a transmitted frame (step 445) and if this frame has been transmitted using the old MAC address, the station compares the receiving MAC address (RA) of the acknowledgment frame with the emitting address of the corresponding transmitted frame.

Next, after having received an acknowledgment or if no acknowledgment is to be received, the station having sent the frame determines whether the old MAC address of the considered non-AP station is still used and thus, whether the change of MAC address is done. If both the LocalBF and the RemoteBF bits are set to true, the station determines that the old MAC address does not need to be maintained anymore and thus, that the transition period may be terminated (as described by reference to steps 315 and 365 in FIGS. 3a and 3b, respectively).

FIG. 6 illustrates a first example of a sequence of steps for operating a procedure for changing the MAC address of a non-AP station associated with an AP station, according to some embodiments of the invention.

The MAC address changing procedure basically comprises two phases: a first phase during which new MAC addresses for one or more non-AP stations are computed and during which the AP station and the one or more non-AP stations identify the effective change start time, and a second phase corresponding to an effective change of the MAC addresses of these non-AP stations. The effective change of a MAC address starts at a time called SERCM change start time and ends at the latest at a time called maximum SERCM change end time, from which the new calculated MAC address is used for data exchanges between the considered non-AP stations and the AP station with which they are associated. Therefore, during the changing procedure, each considered non-AP station changes its MAC address from a current value @MAC(n) to a new value @MAC(n+1). During the transition period, both current and new values for the MAC address are valid.

The new MAC address(es) must be calculated by the considered non-AP station(s) and by the AP station. For example, it may be calculated based on the usage of a pseudorandom function (PRF):
@MAC (n+1)=PRF-128/46(ERCM Key, “ERCM”, @MAC (n), 128)

The PRF is a function of four parameters K, A, B, and Len. Len represents the length of the result of the function, i.e. the number (128, 192, 256, etc.) of bits pseudo randomly generated, K is a secret key coded on 256 bits, A is a text string specific to the application for which the PRF is used and B is a variable length string. In the RCM procedure of the standard IEEE Std 802.11-2020, the PRF-128, i.e. PRF(K, A, B, 128), which generates 128 pseudorandom bits, is used.

At the SERCM change start time, the non-AP station(s) and the AP station start the effective change address procedure and, at the maximum SERCM change end time (or earlier), they modify their respective registry by updating the MAC address of each of the considered non-AP stations from @MAC(n) to @MAC(n+1).

In other words, at the starting of the transition period, both AP and non-AP STA initiate the MAC address change for the changing non-AP STA.

The way the AP station and the non-AP stations determine the new MAC addresses to be used is out of scope of the disclosure. The AP station and the non-AP stations may, for instance, store a list of MAC addresses, and each time a change of MAC address must be performed, the next value in the list is chosen as the new MAC address. Such embodiments could however present security problems, if a third party had access to the list. Alternatively, the same function may be used by a non-AP station and the AP station with which it is associated to determine, for example, an index of the next MAC address to use in a predetermined list of MAC addresses. This index may be advantageously determined randomly.

Another MAC address selection method can be used. For example, it may be based on the usage of a pseudorandom function (PRF) with the same input parameters. Therefore, both a non-AP station and the AP station with which it is associated obtain the same address value @MAC(n+1).

Back to FIG. 6 and by reference to FIG. 1, it is illustrated a changing procedure initiated by AP station 105 and intended to non-AP stations 110a and 110b of the BSS for which the initiation procedure has been performed. In other words, according to these embodiments, AP station 105 indicates to non-AP stations 110a and 110b for which the initiation procedure has been performed that they have to change their respective MAC addresses, and non-AP stations 110a and 110b initiate the change of their respective MAC addresses at the same time (the SERCM change start time).

For the sake of illustration, the SERCM change start time may be expressed in terms of a number of Target Beacon Transmission Times (TBTTs). Of course, the SERCM change start time may be expressed differently, for example as an actual time (which may be rounded to avoid any problem due to an imperfect synchronization of the clocks of the non-AP and AP stations).

According to IEEE 802.11 standards, an AP station periodically (every TBTT) transmits beacon frames to the non-AP stations of the BSS, which are management frames containing information relative to the network. Therefore, beacon frames may include a field storing an item of information to indicate a SERCM change date. For example, such an item of information may represent a value of a counter that is decremented within each successive beacon frame transmitted by the AP station so as to indicate that a change of MAC address is in progress and to indicate the SERCM change date. For example, each beacon frame transmitted by AP station 105 to non-AP stations 110a and 110b of the BSS may contain an information element. The counter may be initially set to a value corresponding to the time at which the change must be operated (for instance, an initial value of k may indicate that the change must be operated in (k+1) TBTTs, k being an integer), and decremented of one unit at each transmission of a next beacon frame. When the counter reaches the value 0, the change must be operated. Therefore, all transmissions of frames subsequent to the beacon frame associated with a counter equal to 0 must be performed with the new MAC address.

With reference to FIG. 6, non-AP stations 110a and 110b receive a beacon frame including a counter, denoted SERCM Change counter, initially set to value k (step 600). It indicates that non-AP stations 110a and 110b (for which an initiation procedure has been done) must change their respective MAC addresses at a time corresponding to (k+1) TBTTs. Then, a next beacon frame is sent from AP station 105 to non-AP stations 110a and 110b (step 605), comprising SERCM Change counter with a value (k−1). After (k+1) beacon frame transmissions, AP station 105 sends a beacon frame with SERCM Change counter equal to 0 to non-AP stations 110a and 110b (step 610), indicating that the change of the respective MAC addresses of non-AP stations 110a and 110b must be initiated. The new addresses of non-AP stations 110a and 110b should be determined at any time between steps 600 and 610, that it to say after requesting the MAC address change and before starting the effective MAC address change.

All the transmissions between AP station 105 and non-AP stations 110a and 110b, occurring after max. SERCM change end time 615, should be performed with the new MAC addresses of non-AP stations 110a and 110b.

The transition duration (referenced 620) between SERCM change start time 610 and max. SERCM change end time 615 advantageously allows the AP station and the non-AP stations to transmit the frames addressed with the old MAC address @MAC(n) that were buffered in their transmission buffer. This allows changing the MAC address without breaking the on-going transmissions, making it possible that frequent MAC address changes do not have negative effects on the performances.

Even if the embodiments described by reference to FIG. 6 use beacon frames, it has to be understood that other types of frames may be used similarly.

FIG. 7 illustrates a second example of a sequence of steps for operating a procedure for changing the MAC address of a non-AP station associated with an AP station, according to some embodiments of the invention.

According to the alternative embodiments illustrated in FIG. 7, the MAC address changing procedure may be initiated by non-AP station 110a.

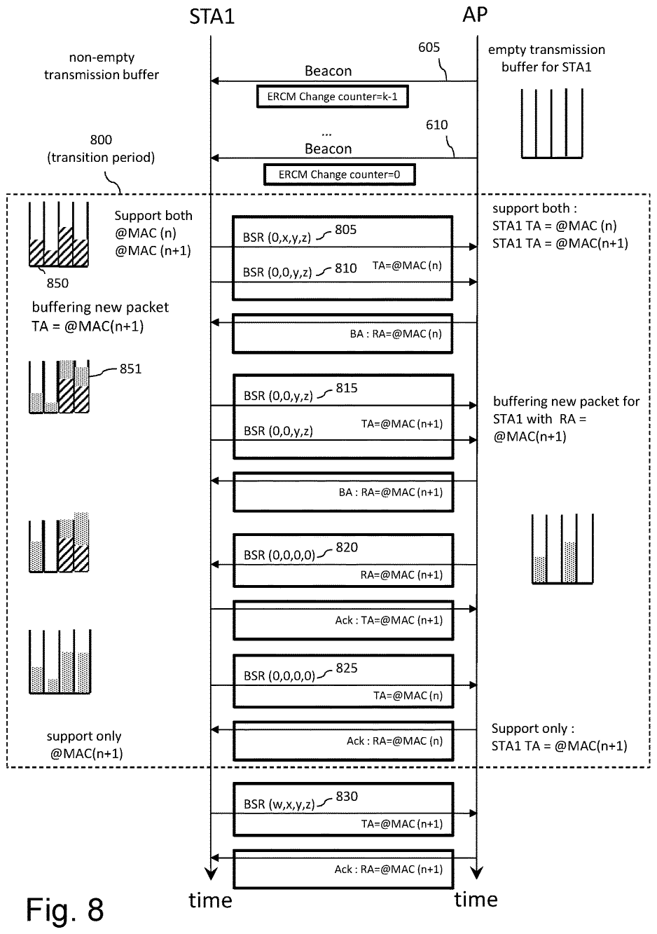

As illustrated, a request for changing the MAC address of the considered non-AP station (i.e. non-AP station 110a in this example) is sent from non-AP station 110a to AP station 105 (step 700). This request may be an “SERCM change Request”, for example “SERCM change Request” 800 as described below with reference to FIG. 8. This request may contain an indication relative to the SERCM change date and to the SERCM max. transition period duration.

For the sake of illustration, it may comprise a field (e.g. a SERCM Change Date field 815, as illustrated in FIG. 8) indicating, for example in terms of TBTTs, the date of the next MAC address change. For example, a value set to k may indicate that the change must be operated in (k+1) TBTTs, and a value set to 0 may indicate that the next MAC address is to be applied immediately. Accordingly, all message transmissions subsequent to the transmission of the beacon frame associated with a counter equal to 0 should be performed by using the new MAC address.

The SERCM change request frame may also contain a field (e.g. a SERCM max. transition period field 820, as illustrated in FIG. 8) indicating the maximum duration of the transition period. At the expiration of the transition period, both the AP station and the non-AP station should use the new MAC address.

As illustrated, in response to the request for changing the MAC address, AP station 105 may acknowledge that it has received the request and that it agrees to change the MAC address of non-AP station 110a (step 705), for example by sending to non-AP station 110a a “SERCM change Response”.

According to some embodiments, non-AP station 110a may implement a counter reflecting the SERCM change date (e.g. a counter equal to k or (k−1)) when it sends the request for changing its MAC address, the SERCM change date being here expressed in a number of TBTTs. Each time a new beacon frame is received from AP station 105, the counter may be decremented by one unit. Upon reception by non-AP station 110a, from AP station 105, of the beacon frame corresponding to the SERCM date, i.e. when the counter reaches the value zero (step 710), the change of the MAC address is initiated. At the end of the transition period (reference 720), the new MAC address of non-AP station 110a is effective (at the beginning of the next TBTT). This means that all transmissions subsequent to the transmission of the beacon frame corresponding to the maximum SERCM change end time (step 715) are done with the new MAC address.

It is noted that the new addresses of non-AP station 110a should be determined at any time between steps 700 and 710, that it to say after requesting the MAC address change and before starting the effective MAC address change.

Although the examples described with reference to FIGS. 6 and 7 are based on the use of beacon frames and TBTTs, there exist other embodiments. Indeed, according to some embodiments, it may be needed to share, between the considered non-AP stations and the AP station with which they are associated, an indication relative to the time at which the change is to be made, and to provide the non-AP stations and the AP station with means for counting the time. For example, it is possible to send an actual date, as long as the non-AP station and the AP station have access to the same clock or can synchronize their clocks. Changes of MAC addresses may be performed periodically, at predetermined times, or on requests.

It is also noted that, based on the example illustrated in FIG. 6, an AP station may request that only one non-AP station changes its MAC address. To that end, a SERCM change request similar to the one described by reference to FIG. 7 may be sent from the AP station to the considered non-AP station.

FIG. 8 Illustrates a first example of steps performed by a non-AP station and its associated AP station during a multi MAC address period 800, corresponding to a MAC address transition period of a station, according to some embodiments of the invention. For the sake of illustration, the example in FIG. 8 is based on the one illustrated in FIG. 6. Accordingly, the AP station determines that the starting time of the transition period should begin after the transmission of k beacon further to transmitting beacon 605. Upon reception of beacon 605, non-AP station STA1 also determines the future starting time of the transition period 800. Therefore, upon transmission of beacon 610, the AP station enters in the transition period for STA1 MAC address and upon reception of beacon 610, STA1 enters the transition period of its MAC address. Between beacon 605 and beacon 610, both the AP station and STA1 compute the new STA1 MAC address using the same algorithm and the same parameters (ending up with the same MAC address value). It is noted that the detail of the new MAC address computation is out of scope of the present description.

Upon reception of beacon 610, reception STA1 enters the transition period. At that time, both the new MAC address and the old MAC addresses are valid MAC addresses for STA1 from the point of view of the AP station and of STA1.

In this example, STA1 has some data 850 addressed with the old MAC address (e.g. packet with TA=@MAC (n)) stored in each of its buffers corresponding to different traffic types (for instance, different access categories as described by IEEE 802.11e amendment). Still for the sake of illustration, the buffers of the AP station do not store any data to be addressed to STA1 using the old MAC address.

When STA1 gains access to the medium (in this example, when the first access category backoff reaches zero), STA1 sends data corresponding the first access category and addressed with the old MAC address (i.e., the transmission address (TA) is @MAC(n)). It empties this first access category by sending a first frame. The content of the BSR included in this first frame then indicates that the first AC is empty by including a BSR (0,x,y,z), referenced 805.

BSR (w,x,y,z) is a notation used in the following to indicate a BSR representative of content for the four access categories equal respectively to w bytes, x bytes, y bytes, and z bytes. For instance, this can be encoded in a BSR, for example BSR 260 in FIG. 2, by indicating the total amount of data in the subfield 266 (Queue Size all) which is w+x+y+z. Accordingly, a BSR having its subfield 266 containing a value greater than zero indicates that STA1 still have some data addressed with the old MAC address. Different encodings are possible for such BSR (for instance using different Scaling Factor 264 values), but the important point for the invention is that the subfield 266 is not equal to zero and only represents data addressed with the old MAC address. In this example, during the same transmission opportunity, STA1 also sends data from another access category (possible in the case of an access category having a higher priority than the first transmission in this TXOP only if the MAC address of the frame is the same as the first one). This rule is a little different from the standard rule as defined in the IEEE 802.11 series, but allows a station to use its TXOP during the transition period efficiently while avoiding mixing the transmission of frames addressed with different source MAC addresses in the same transmission opportunity.

Accordingly, STA1 sends data corresponding to this other access category and addressed with the old MAC address. Still for the sake of illustration, it is considered that it empties this other access category by sending the corresponding frame. Therefore, the content of the BSR included in this frame indicates that the first AC and the other AC are empty by including a BSR (0,0,y,z), referenced 810.

In response, the AP station acknowledges reception of the frames using a block acknowledgement (BA) having the old MAC address (i.e., the receiving address (RA) is @MAC(n)).

It is observed that avoiding the transmission of different frames addressed with different MAC addresses during the same transmission opportunity is very advantageous from a privacy point of view, since it avoids an easy correlation between the old and the new MAC addresses. The proposed mechanism for data selection during transition period in which the two MAC addresses are potentially used then makes tracking of the device much more difficult.

In the example of the FIG. 8, it is considered that new data 851 are buffered using the new MAC address as source address (e.g. packet with TA=@MAC (n+1)) between the last transmission opportunity and the next one. When, at the next transmission opportunity, STA1 gains the medium for a traffic, it may transmit frames containing only data addressed with the new MAC address (i.e., the transmission address (TA) is @MAC(n+1)). STA1 then transmits data frames addressed with the new MAC address, but since no data have been sent with the old MAC address since the last transmission opportunity, the amount of data in the buffers, using the old MAC address, has not changed, resulting in the same BSR in these frames as the one transmitted in the last frames of the last TXOP sending frames addressed with the old MAC address, i.e. BSR(0,0,y,z), referenced 815.

In this example, when STA1 receives a data frame from the AP station including a BSR 820 of the BSR (0,0,0,0) type, indicating that the AP station has no data stored for the station addresses with the old STA1 MAC address, STA 1 set its RemoteBF bit to true indicating that the remote station (AP station in this example) is ready to use only STA1 new MAC address. It is noted here that the AP station informs STA1 that the AP station has no data stored for STA1 with the old MAC address after having received a data frame from STA1 with the new MAC address.

Finally, when STA1 successfully transmits its last frame addressed using its old MAC address, STA1 includes a BSR 825 of the BSR (0,0,0,0) type to indicate to the AP station that there is no more data to be sent with the old MAC address and that STA1 is ready to use only the new MAC address. STA1 sets its LocalBF bit to 1. Since both STA1 and the AP station then determine that there is no data addressed with the old STA1 MAC address in AP station's or STA1's buffer, the transition period ends, and the old STA1 MAC address can be discarded.

After the end of the transition period, the BSR computation is done using the total amount of data buffered on stations regardless of the MAC address used to address the frames as illustrated with BSR 830 that is similar to BSR 260 in FIG. 2.

This example illustrated how the usage of a BSR computed according to the buffered frames addressed with the old MAC address during the multi MAC address period (i.e. the transition period in this case), that is to say in a particular context, makes it possible to determine the end of a transition period without ambiguity and without waiting for the expiration of a transition timer. Thanks to this mechanism to determine the end of this transition period based on Buffer Status Report (BSR) exchange, the duration of the transition period is reduced and the BSR may be also used to indicate old data to be scheduled.

FIG. 9 illustrates a second example of steps performed by a non-AP station and its associated AP station during a multi MAC address period 900, corresponding to a MAC address transition period of a station, according to some embodiments of the invention, where there is no data buffered at the beginning of the transition period.

As soon as STA1 enters the transition period, STA1 immediately sets its LocalBF bit to true. Accordingly, STA1 prepares a QoS NULL frame 905 containing a BSR 910 similar to BSR 825 in FIG. 8, and sends it to the AP during it next transmission opportunity, instead of waiting for potential data to transmit or waiting for the expiration of a transition timer.

When STA1 receives a data frame from the AP station including a BSR 915 of the BSR (0,0,0,0) type, indicating that the AP station has no data stored for the station addressed with the old STA1 MAC address, STA 1 set its RemoteBF bit to true indicating that the remote station (the AP station in this example) is ready to use only STA1 new MAC address.

This allows STA1 to shorten the duration of the transition period.

In summary, embodiments of the invention generally allow to put in place a mechanism in order to proceed to a MAC address change while associated without breaking the ongoing communications. The mechanism relates to data selection during transition period in which two MAC addresses are potentially used, and to determine the end of this transition period based on Buffer Status Report (BSR) exchange. Embodiments of the invention advantageously handle the transition period by providing rules for data selection and by determining the end of the transition period thanks to the usage of a BSR to indicate quantity of remaining packets addressed with and old MAC address. Particular benefits of these embodiments may be listed, non-imitatively, as follows:
user privacy is enhanced by allowing a station to change its MAC address while associated without break of ongoing communication;
the change of MAC address is not easily detectable since additional mechanism described here are based on existing signaling (BSR);
the duration of the transition period is reduced and the BSR may be also used to indicate old data to be scheduled.

It is to be noted that although the previous description is mainly based on changes of MAC addresses within non-AP stations, for the sake of illustration, changes of MAC addresses within AP stations may be handled similarly.

### Use of Different Valid MAC Addresses

As described above, the support of several valid MAC addresses may be provided in a station to increase the station privacy, for example by using a different MAC address per type of communication. This is the case for stations using a MAC address for the data transmission and another MAC address for the performing positioning determination, or performance feedback.

In such a case, the amount of buffered data that correspond to data that are addressed to a remote station in a frame may be indicated in a BSR included in the transmitted frame. For example, if the transmitted data are data related to performance feedback, the station may determine the amount of buffered data that relate to performance feedback and indicate this amount in a BSR. Since the remote station has knowledge about the type of data received in the frame, it may interpret appropriately the BSR received in this frame and determine the amount of data of the same type of the received data that still need to be sent. In such a case, the type of data is used to identify a MAC address that in turn makes it possible to determine an amount of buffered data.

According to other embodiments, a context indicator that makes it possible to identify a context, a feature, or communication type and then corresponding MAC address and thus, an amount of buffered data associated with this MAC address, may be exchanged between the station and the remote station. Such explicit signaling of a context indicator may be used to share information regarding an amount of buffered data that are associated with a particular MAC address. For example, this context indicator may be present in a BSRP trigger frame requesting a receiving station to send back a BSR.

### Example of Hardware to Carry Out Steps of the Method of Embodiments of the Present Disclosure

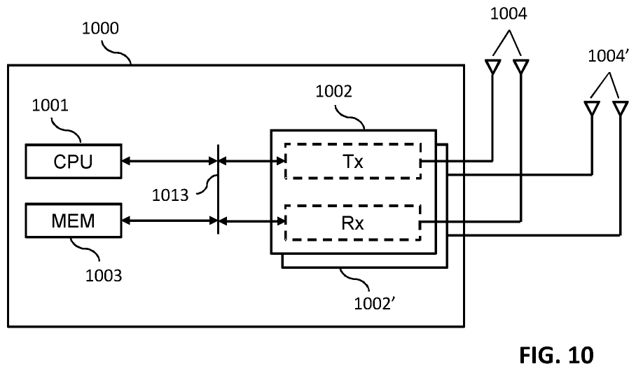

FIG. 10 schematically illustrates an example of a communication device, that may correspond any of the stations described by reference to FIG. 1, of a wireless network, configured to implement at least some embodiments of the present invention. The communication device, referenced 1000, may preferably be a device such as a micro-computer, a workstation, or a light portable device. Communication device 1000 may comprise a communication bus 1013 to which may be connected:
a central processing unit 1001, such as a processor, denoted CPU;
a memory 1003, denoted MEM, for storing an executable code of methods or steps of the methods according to embodiments of the invention as well as the registers adapted to record variables and parameters necessary for implementing the methods; and
at least two communication interfaces 1002 and 1002′ connected to the wireless communication network, for example a communication network according to one of the IEEE 802.11 family of standards, via transmitting and receiving antennas 1004 and 1004′, respectively.

Preferably, communication bus 1013 may provide communication and interoperability between the various elements included in the communication device 1000 or connected to it. The representation of the bus is not limiting and in particular the central processing unit is operable to communicate instructions to any element of the communication device 1000 directly or by means of another element of the communication device 1000.

The executable code may be stored in a memory that may either be read only, a hard disk, or on a removable digital medium such as for example a disk. According to an optional variant, the executable code of the programs can be received by means of the communication network, via the interface 1002 or 1002′, in order to be stored in the memory 1003 of communication device 1000 before being executed.

In some embodiments, communication device 1000 may be a programmable apparatus which uses software to implement embodiments of the invention. However, alternatively, some embodiments of the present invention may be implemented, totally or in partially, in hardware (for example, in the form of an Application Specific Integrated Circuit or ASIC).

Embodiment(s) of the present invention can also be realized by a computer of a system or apparatus that reads out and executes computer executable instructions (e.g., one or more programs) recorded on a storage medium (which may also be referred to more fully as a “non-transitory computer-readable storage medium”) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), etc.), a flash memory device, a memory card, and the like.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

A person skilled in the art will readily appreciate that various parameters disclosed in the description may be modified and that various embodiments disclosed may be combined without departing from the scope of the invention.

1. A method of communication in a wireless network comprising a plurality of stations, the plurality of stations comprising an emitting station having a plurality of Extended Unique Identifiers, EUIs, simultaneously valid and having at least one buffer to store data to be transmitted to a destination station, the method comprising, at the emitting station:
generating a buffer status report, BSR, to be transmitted to the destination station, the BSR indicating an amount of data stored in the at least one buffer of the emitting station, the amount of data being determined as a function of an EUI of the plurality of EUIs, the EUI used for determining the amount of data being used as a source address for transmitting the data.

2. The method of claim 1, further comprising
identifying the EUI used for determining the amount of data as a function of a context.

3. The method of claim 2, wherein the context is a change of EUI, within the emitting station, from an old EUI to a new EUI, the EUI used for determining the amount of data being the old EUI.

4. The method of claim 3, further comprising
determining that the at least one buffer of the emitting station does not comprise any data to be transmitted using the old EUI and setting a global queue size field of the BSR to zero.

5. The method of claim 4, further comprising preparing a Quality of Service, QoS, NULL frame, the prepared QoS NULL frame comprising the BSR wherein the global queue size field is set to zero.

6. The method of claim 3, further comprising
receiving a frame from the destination station, the frame received from the destination station comprising a BSR, wherein the BSR received from the destination station comprises a global queue size field set to zero.

7. The method of claim 6, further comprising deactivating the old EUI upon determining that the global queue size field of the BSR received from the destination station is set to zero.

8. The method of claim 3, further comprising
activating a timer when a change is to be carried out between the old EUI and the new EUI and comprising deactivating the old EUI when the timer elapses.

9. The method of claim 2, wherein the context is determined as a function of a type of data to be transmitted.

10. The method of claim 9, wherein the context is received from the destination station.

11. The method of claim 1, wherein the destination station is an access point station, AP, and the emitting station is a non-AP station, STA.

12. A method of communication in a wireless network comprising a plurality of stations, the plurality of stations comprising an emitting station having at least one buffer to store data to be transmitted to a destination station, the destination station having a plurality of Extended Unique Identifiers, EUIs, simultaneously valid, the method comprising, at the emitting station:
generating a buffer status report, BSR, to be transmitted to the destination station, the BSR indicating an amount of data stored in the at least one buffer of the emitting station, the amount of data being determined as a function of an EUI of the plurality of EUIs, the EUI used for determining the amount of data being used as a destination address for transmitting the data.

13. The method of claim 12, further comprising identifying the EUI used for determining the amount of data as a function of a context.

14. The method of claim 13, wherein the context is a change of EUI, within the destination station, from an old EUI to a new EUI, the EUI used for determining the amount of data being the old EUI.

15. The method of claim 14, further comprising receiving a frame from the destination station, the frame received from the destination station comprising a BSR, wherein the BSR received from the destination station comprises a global queue size field set to zero.

16. The method of claim 15, further comprising determining that the at least one buffer of the emitting station does not comprise any data to be transmitted to the destination station using the old EUI as a destination address and setting a global queue size field of the BSR to zero.

17. The method of claim 16, further comprising deactivating the old EUI.

18. The method of claim 14, further comprising activating a timer when a change is to be carried out between the old EUI and the new EUI and comprising deactivating the old EUI when the timer elapses.

19. The method of claim 13, wherein the context is determined as a function of a type of data to be transmitted.

20. The method of claim 19, wherein the context is transmitted to the destination station.

21. The method of claim 12, wherein the emitting station is an access point station, AP, and the destination station is a non-AP station, STA.

22. The method of claim 1, further comprising transmitting the generated BSR to the destination station.

23. The method of claim 1, wherein the EUI used for determining the amount of data is a MAC address.

24. The method of claim 1, wherein the at least one buffer comprises a plurality of queues, each queue of the plurality of queues corresponding to an Access Category, AC.

25. (canceled)

26. A non-transitory computer-readable storage medium storing instructions of a computer program for implementing each of the steps of the method according to claim 1.

27. A communication device comprising a processing unit configured for carrying out each of the steps of the method according to claim 1.
